(19) United States
(12) Patent Application Publication
(10) Pub. No.: US 2017/0183545 A1
(43) Pub. Date: Jun. 29, 2017

(54) ANTIVIRAL, ANTI MICROBIAL PROTECTION FOR TOUCH SURFACES

(71) Applicant: Michael Stephen KELLEHER, Mobile, AL (US)

(72) Inventor: Michael Stephen KELLEHER, Mobile, AL (US)

(21) Appl. No.: 15/320,376

(22) PCT Filed: Jun. 19, 2015
(86) PCT No.: PCT/US15/36597

§ 371 Date: Dec. 20, 2016

Related U.S. Application Data
(60) Provisional application No. 62/014,889, filed on Jun. 20, 2014.

(51) Int. Cl. C09J 7/02; B32B 15/04; A01N 59/20

(52) U.S. Cl. CPC C09J 7/0296; C09J 7/0292; A01N 59/20; B32B 15/04; C09J 2400/163

(57) ABSTRACT

Methods for preventing the transmission of viral and bacterial diseases are disclosed. Disease transmission is inhibited through the application of an antimicrobial film to touchpoints, the antimicrobial film having at least 60 percent copper and being at least 0.0001 mm.

### CROSS REFERENCE TO RELATED APPLICATIONS

This application claims priority to U.S. application 62/014,889, filed on Jun. 20, 2014, the contents of which are incorporated in its entirety.

### FIELD OF THE INVENTION

The present invention generally relates to preventing the transmission of viral and bacterial diseases. More particularly, the present invention relates to a metal coating or cover providing viral/microbial protection for everyday touch surfaces.

### BACKGROUND OF THE INVENTION

Many infectious diseases are transmitted through contact with touch surfaces, such as, but not limited to writing pens, hospital beds, door knobs, light switches, bathroom hardware, subway grab rails, trains, planes, etc. These touch surfaces can carry pathogenic bacteria, or other disease-causing microrganisms for 30 days or more.

While these surfaces can be (and usually are) periodically disinfected, it is impossible to manually cleanse these touch surfaces after every individual contact. This would be impractical, expensive, time consuming, and could even lead to the emergence of resistant pathogens.

It is known that surfaces of copper and its alloys, such as brass and bronze, exhibit antimicrobial properties. They have an inherent ability to kill a wide range of harmful microbes relatively rapidly and with a high degree of efficacy. Research suggests that if touch surfaces were to be made with copper alloys, the transmission of disease-causing organisms could be reduced by over 50 percent. Such a reduction could then reduce patient infections in care sites such as hospital intensive care units. As an example, the Environmental Protection Agency has approved the registrations of close to 500 different compositions of copper alloys “antimicrobial materials” with public health benefits.

However, the prospect of replacing all items having touch surfaces with new units that contain a solid copper surface is cost prohibitive.

What is needed is a means of obtaining the benefit of a copper or copper alloy surface without the cost of replacing every item and/or the cost of creating the item out of copper or copper alloy

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides a means for preventing the transmission of viral and bacterial diseases. The present invention relates to a metal coating or cover providing viral/microbial protection for everyday touch surfaces. The present invention provides a means to retrofit existing infrastructure with copper alloy surfaces via an inexpensive and efficient process.

It is an object of the present invention to provide a protective film for application to touch points such as light switches, pens, door handles, hand rails and the like.

It is a further object to provide a protective film that is a wrap or adhering copper foil.

It is a further object to provide a copper foil sheet of purity: 60.0-99.99 within the range of 0.0001 mm to 1.0 mm inches thick.

It is a further object to provide a sheet that is a copper alloy and is 60-99.9 percent copper.

It is a further object to provide an overlay for inhibiting transmission of infection disease, the overlay including an antimicrobial film, wherein the antimicrobial film is least 60 percent copper and at least 0.0001 mm; and has an adhesive backing.

It is a further object to provide an overlay Wherein the adhesive backing has a protective cover.

It is a further object to provide an overlay wherein the antimicrobial film has a medium side and a contact side, and the overlay includes further antimicrobial moisture proof backing adjacent to the antimicrobial film on the medium side, antimicrobial absorption fabric adjacent to the antimicrobial moisture proof backing, and an antimicrobial cushion adjacent to the antimicrobial film on the contact side.

It is a further object to provide a method for inhibiting transmission of infection disease, wherein the method includes adhering an antimicrobial film, to a touch point, the antimicrobial film being at least 60 percent copper and at least 0.0001 mm.

It is a further object to provide a method for inhibiting transmission of infection disease where the antimicrobial film is adhered to a touchpoint with heat or an organic solvent.

It is a further object to provide a method for inhibiting transmission of infection disease by metalizing a touch point with at least 60 percent copper at a depth of at least 0.0001 mm.

It is a further object to provide a method for inhibiting transmission of infection disease by metalizing a touch point with at least 60 percent copper at a depth of at least 0.0001 mm where the metalizing is via vacuum metallization, arc spraying, flame spraying, electroplating, electroless plating or PVD thin film deposition

### BRIEF DESCRIPTION OF THE DRAWINGS

For a more complete understanding of the nature and desired objects of the present invention, reference is made to the following detailed description taken in conjunction with the accompanying drawing figures wherein like reference characters denote corresponding parts throughout the several views.

FIG. 1 illustrates the bonding of the antimicrobial film wrap to a medium.

FIG. 2 Illustrates potential components of the present invention. Varying embodiment can include one or more of these components.

FIG. 3 Illustrates the present invention as applied to a condiment grinder or shaker.

FIG. 4 Illustrates a cross section of the manufactured assembly.

### DETAILED DESCRIPTION

Microorganisms are known to survive on inanimate touch surfaces or touch points for extended periods of time. This can be especially troublesome in hospital environments where patients are at enhanced risk for contracting hospital-borne infections. This can result in fatal consequences particularly when the patient is immune compromised. Touch surfaces commonly found in hospital rooms, such as bed rails, call buttons, keyboards, touch plates, chairs, door handles, light switches, grab rails, intravenous poles, dispensers (alcohol gel, paper towel, soap), dressing trolleys, and counter and table tops are known to be contaminated with high levels of potentially dangerous bacteria, including Staphylococcus, Methicillin-resistant Staphylococcus aureus (MRSA), one of the most virulent strains of antibiotic-resistant bacteria and Vancomycin resistant Enterococcus (VRE). Objects in closest proximity to patients have the highest levels of staphylococcus, MRSA, and VRE. Thus, touch surfaces in hospital rooms can serve as abundant sources, or reservoirs, for the spread of bacteria from the hands of healthcare workers and visitors to patients. Hand and surface disinfection practices are the first line of defense against infection. However, these are often not adequate. EPA testing shows copper begins killing viruses and microbes instantly and the most serious germs in two hours without cleaning between the introduction of new viruses.

The present invention provides a cost effective means of obtaining the benefits of replacing touch points with copper/copper alloy without the concomitant costs.

In one embodiment the thickness of the wrapping will be 0.0001 mm or greater. Wrapping thickness is dependent on the area and shape of the touch point surface. Thickness is modified to ensure a securely applied wrap. In one embodiment the wrap includes copper, bronze, or brass. Wrapping thickness can also be dependent upon likely traffic at the particular touch point. Higher traffic can require greater thickness.

The proposed backing, or adhesion method, would vary depending on the desired application, existing surface, and host item. For light, or low-traffic applications, a thin foil could be adhered with an epoxy or light adhesive backing. For certain types of plastic surfaces, the plastic could be treated with heat or an organic solvent to “melt” the host surface before the foil (with an acceptably rough backing) is applied. For high-traffic applications, such as a subway railing, a thick/sturdy mold could be manufactured that is installed over the existing item or a sheet could be welded in place onsite. Lighter applications, such as those with adhesives, could be removed and replaced as necessary, and thicker sheets could be manufactured within molds that are bolted into place for repair/replacement as necessary. In addition to metalizing a transfer film, and using alternative methods to apply the film to the surface of the substrate, one could metalize the touch point. This could be done via vacuum metallization, arc spraying, flame spraying, electroplating, electroless plating or PVD thin film deposition.

The proposed product would be available in varying dimensions. Small rectangular sheets would be ideal for handles on hospital beds, pull handles on doors, etc., while very long and thin sheets would be appropriate for railings. Smaller and/or irregularly shaped products for mass-manufacturing could have a mold that is designed to fit while accommodating for any irregularities. As one example, the clip on the side of a pen could be cut out of the flat mold.

Large rolls of varying thickness, like sheet metal, could be purchased and die could be used to cut out the necessary individual products at any desired size. These could be individually packaged for private sale, or shipped in mass to large manufacturers. For large, on-site work, such as a hospital or public project (i.e. subway system), an installation team could be trained and equipped with the necessary equipment to retrofit existing infrastructure. For some applications, smaller rolls of the raw metal/alloy could even be used to cut custom pieces onsite.

In one embodiment the protective film is at least 99 percent copper. In an alternative embodiment the protective film is at least 90 percent copper. In a further alternative embodiment the protective film is at least 75 percent copper. In a further alternative embodiment the protective film is at least 60 percent copper Lower percentages are contemplated. Such percentages will continue to provide beneficial effect. However would not be as efficacious.

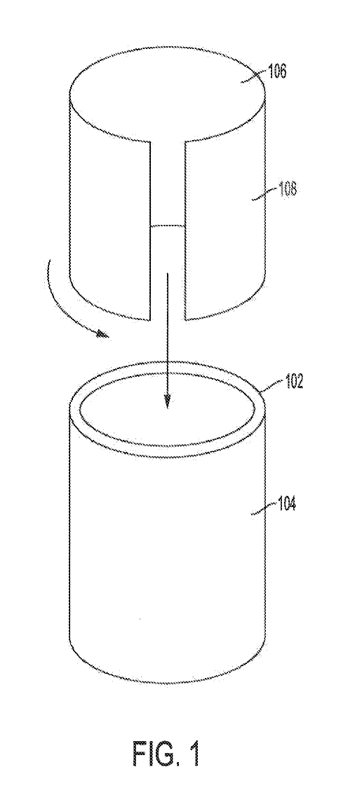

FIG. 1 illustrates the bonding of the antimicrobial film wrap to a medium. In this example, medium 102 is a cylindrical solid or flexible medium consisting of plastic, vinyl, metal, cardboard, paper, glass or fabric. It is noted that the medium could be of a variety of sizes and/or shapes. In one embodiment, the adhesive system of the present invention comprises medium adhesive 104 and film adhesive 106. Medium adhesive 104 is topically applied by a user to medium 102. Film adhesive 106 is either topically applied by a user to antimicrobial film 108 or is pre-applied by a manufacturer. The adhesive system bonds the antimicrobial film to the medium. In at least one embodiment a removable protective covering overlays film adhesive 106. In certain embodiments medium adhesive 104 is not required.

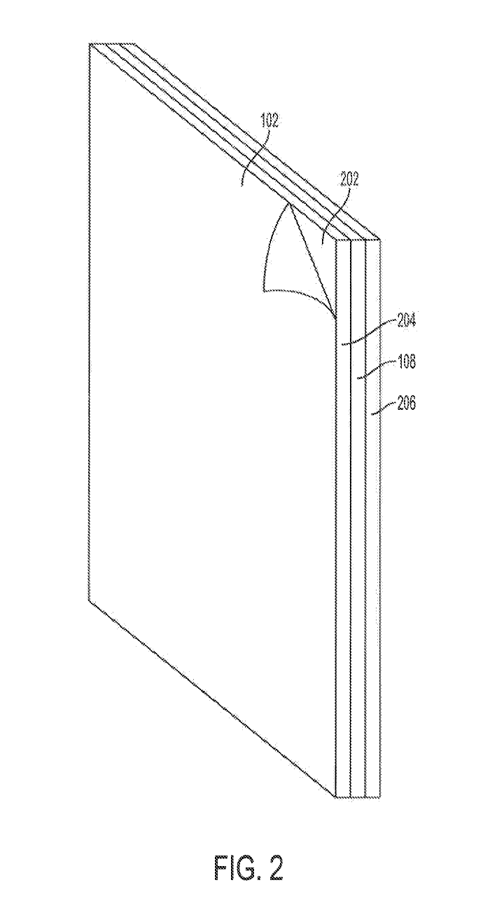

FIG. 2 Illustrates potential components of the present invention. Varying embodiments can include one or more of these components. As illustrated, adjacent to medium 102 is antimicrobial absorption fabric 202. Adjacent to antimicrobial absorption fabric 202 is antimicrobial moisture proof backing 204. Adjacent to antimicrobial moisture proof backing 204 is antimicrobial film 108. Adjacent to antimicrobial film 108 is antimicrobial cushion 208.

In at least one embodiment, antimicrobial film is bonded to a solid molding plastic. In a further embodiment, an assembly is provided to manufacture templates for existing products for which a template is made for a touch surface item, and the assembly is pressed and formed to match and applied to touch surface item.

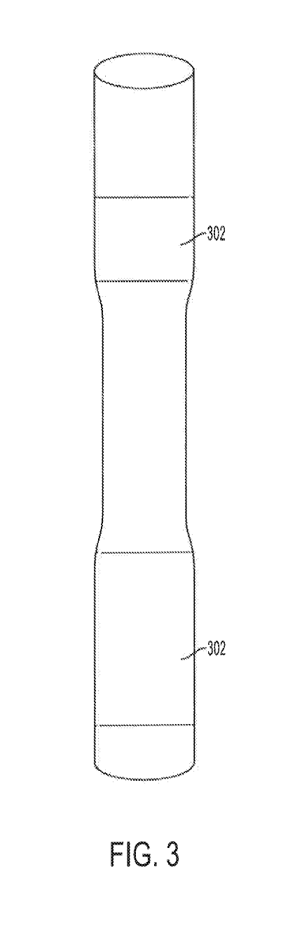

FIG. 3 Illustrates application of the present invention to a condiment grinder or shaker and further illustrates the manufactured assembly to protect touch contact surfaces 302.

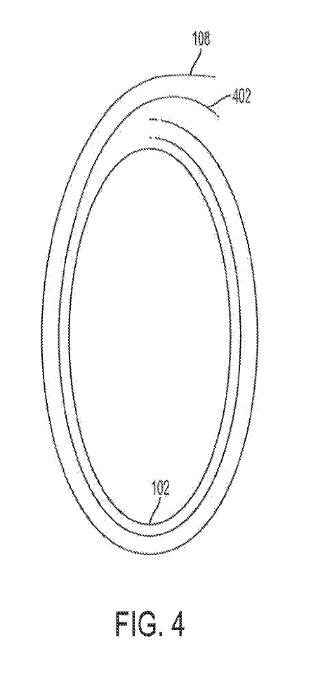

FIG. 4 Provides a cross section of the manufactured assembly to protect touch contact surfaces 302. Illustrated are medium 102, adhesive system 402, and antimicrobial film 108. In various embodiments medium can be plastic, vinyl, glass, metal, cardboard, paper, and the like.

Use outside of the hospital care giver environment to slow the spread of infectious disease is further contemplated. One example of such use would be to minimize the spread of infectious agents due to the use of writing implements such as pens or pencils. In a further embodiment, the present invention reduces the spread of disease due to the use of writing implements in the restaurant environment.

Applications of the present invention include for example, residential applications, industrial/commercial/manufacturing applications, civic/public sector applications, and defense/military/medical applications. As described below, the specific application may require differences in the manufacturing, adhesion, or installation method. However the general principal of the antimicrobial coating remains the same.

Residential applications: The invention applies to in-home disinfection of touch surfaces that include, but are not limited to, door knobs & locking mechanisms, kitchen/bathroom fixtures, faucets, hand-holds & rails/railings, and toilet flush knobs. For private (residential) application of the invention, a retrofitting product is the most effective that wraps and adheres to the existing fixtures in the home. An adhesive-backed product that is made to fit a specific, or range, of commonly purchased commercial handles and railings will be produced using specifications and dimensions from the manufacturer. Upon wrapping self-adhesive coating, the seam can be sealed via chemical or mechanical means.

Industrial/Commercial/Manufacturing applications: The invention applies to antimicrobial coatings for manufactured products including, but not limited to, condiment containers, stationary/writing products, restaurant check/credit card folders, drinking vessels, new production hand-holds/door knobs/railing/faucets. For the manufacture of new products that incorporate the invention at the time of production, a mold of the product will be used to provide the manufacturing plant with an adhesive or non-adhesive wrap or “skin” that is then chemically, thermally, or mechanically affixed to the product. These products can then be distributed as usual to suppliers.

Civic/Public Sector applications: The invention applies to the installation of antimicrobial surfaces in spaces that are generally accessed by the general public at large. These spaces include, but are not limited to, subway systems, trains/train stations, gas stations/highway rest areas, airports/airline terminals/airplanes, cruise ships, public buildings, parks, and other open spaces frequently accessed by many individuals. To retrofit touch surfaces including, but not limited to, handrails, door handles, drinking fountain touch surfaces, gas pump handholds/touch surfaces, subway railings/handholds, bus/subway/airplane/train armrests and tray tables, etc. These surfaces can be retrofitted en mass with antimicrobial coatings, under contract, but trained teams that have been equipped with pre-fitted and manufactured molds for the specific application. The mold is applied to the surface(s) and adhered by chemical, physical or thermal means, specific to the surface and application.

Defense/Military/Medical applications: The invention applies to the use of antimicrobial products to prevent the spread of infectious diseases in situations where there is a high density of individuals (military bases, naval ships, hospitals, nursing homes, etc.) and/or where the spread of disease through wounds is an immediate concern (i.e. battlefield injuries, bedsores, etc.) The use of a pre-manufactured, flexible, material can be used much like gauze/wound care devices, to prevent the entrance of external pathogens into an open wound/sore during initial care/transport, or the healing process.

It is thought that the system and method of the present invention for inhibiting disease spread through the application of copper/copper alloy will be understood from the foregoing description and it will be apparent that various changes may be made in the form, or manufacture thereof without departing from the spirit and scope of the invention or sacrificing all of its material advantages, the form hereinbefore described being merely a preferred or exemplary embodiment thereof.

What is claimed is:

1. An overlay for inhibiting transmission of infection disease, said overlay comprising:
an antimicrobial film, said antimicrobial film being at least 60 percent copper and at least 0.0001 mm; and
an adhesive backing.

2. The overlay of claim 1, said adhesive backing further comprising a protective cover.

3. The overlay of claim 1, said antimicrobial film having a medium side and a contact side, further comprising:
antimicrobial moisture proof backing adjacent to said antimicrobial film on said medium side;
antimicrobial absorption fabric adjacent to said antimicrobial moisture proof backing; and
antimicrobial cushion adjacent to said antimicrobial film on said contact side.

4. The overlay of claim 1, said antimicrobial film being at least 75 percent copper.

5. The overlay of claim 1, said antimicrobial film being at least 90 percent copper.

6. The overlay of claim 1, said antimicrobial film being at least 99 percent copper.

7. A method for inhibiting transmission of infection disease, said method comprising:
adhering an antimicrobial film, to a touch point, said antimicrobial film being at least 60 percent copper and at least 0.0001 mm.

8. The method of claim 7, said adhering comprising:
treating the touchpoint with heat or an organic solvent; and
applying said antimicrobial foil.

9. A method for inhibiting transmission of infection disease, said method comprising:
metalizing a touch point with at least 60 percent copper at a depth of at least 0.0001 mm.

10. The method of claim 9, wherein said metalizing is via vacuum metallization, arc spraying, flame spraying, electroplating, electroless plating or PVD thin film deposition.
